(19) United States
(12) Patent Application Publication
(10) Pub. No.: US 2015/0006839 A1
(43) Pub. Date: Jan. 1, 2015

(54) SWAPPING POINTERS TO PROCESS DATA STORED IN BUFFERS BY A DATA SOURCE WITHOUT COPYING THE DATA TO SEPARATE STORAGE

(71) Applicant: INTEL CORPORATION, Santa Clara, CA (US)

(72) Inventor: Yen Hsiang Chew, Georgetown (MY)

(21) Appl. No.: 14/125,150

(22) PCT Filed: Dec. 27, 2012
(86) PCT No.: PCT/US2012/071750

§ 371 Date: Dec. 10, 2013

(30) Foreign Application Priority Data
Jan. 6, 2012 (MY) PI 2012000072

(51) Int. Cl. G06F 12/02

(52) U.S. Cl. CPC G06F 12/0238
USPC 711/165

(57) ABSTRACT

Apparatuses and methods of swapping pointers to process data stored in a plurality of buffers by a data source without copying the data to separate storage are provided. Data may be consecutively loaded into a plurality of buffers pointed to by a first pointer by consecutively swapping the first pointer to point to the plurality of buffers. The data loaded in the plurality of buffers can be consecutively processed by consecutively pointing a second pointer to the plurality of buffers by consecutively swapping the second pointer to point to the plurality of buffer.

### BACKGROUND

To process data from a data source (such as a camera or the output of a video processing thread), the data source may sequentially store blocks of data (e.g., frames) into a first buffer and a second buffer so that a data requester (e.g., a separate video processing thread) may copy the data for processing. For example, the data source may store a first block of data into a first buffer. When the first buffer is filled, a “data ready signal” may be provided to the data requestor to indicate that the first buffer is ready to be copied and processed. In response to the data ready signal, the data requestor may copy the data from the first buffer into its own buffer for processing. While the data requestor is reading the data from the first buffer, the data source may store a second block of data to the second buffer. When the second buffer is filled, a “data ready signal” may be provided to the data requestor to indicate that the second buffer is ready to be copied and processed. In response to the data ready signal, the data requestor may copy the data from the second buffer into its own buffer for processing. While the data requestor is reading data from the second buffer, the data source may store a third block of data into the first buffer, where the above process may be repeated until all the data from the data source is supplied to the first and second buffer.

If the rate at Which data is stored in the first and second buffers by the data source is faster than the rate at which a data requestor may copy the data from the buffers, some data may be lost as the data source overwrites data stored in the first and second buffers before the data requester may copy the data. Multiple data requestors may be used to copy the data from the buffer to help prevent data loss.

However, copying the data from the first and second buffers to, among other reasons, separate buffers for processing by one or more data requesters may decrease the overall performance of a system.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram illustrating an example system for storing and processing data from a data source without copying the data to separate memory;

FIG. 2 illustrate an example process to swap pointers to process data stored in the buffer of FIG. 1 by a data source without copying the data to separate storage;

FIGS. 3A and 3B illustrate the load activity of the data source of FIG. 1 and the process activity of data requester of FIG. 1, respectively, based on the process described with reference to FIG. 2;

FIG. 4 is a block diagram illustrating an example computer system for storing and processing data from a data source without copying the data to separate memory;

FIG. 5 is a block diagram illustrating an example system of this disclosure; and

FIG. 6 is a block diagram illustrating an example small form factor device in which components of the system of FIG. 5 may be embodied.

### DETAILED DESCRIPTION

Various implementations of this disclosure provide apparatuses and methods for swapping pointers to process data stored in a plurality of buffers by a data source without copying the data to separate storage.

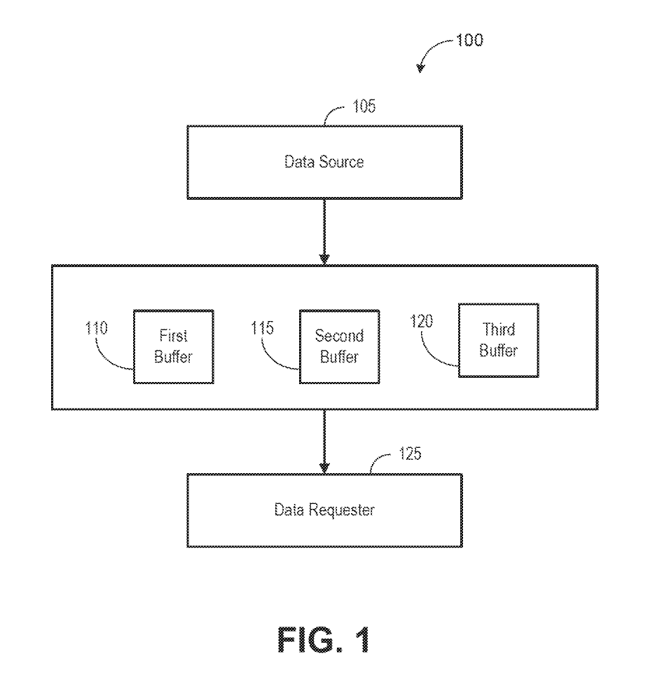

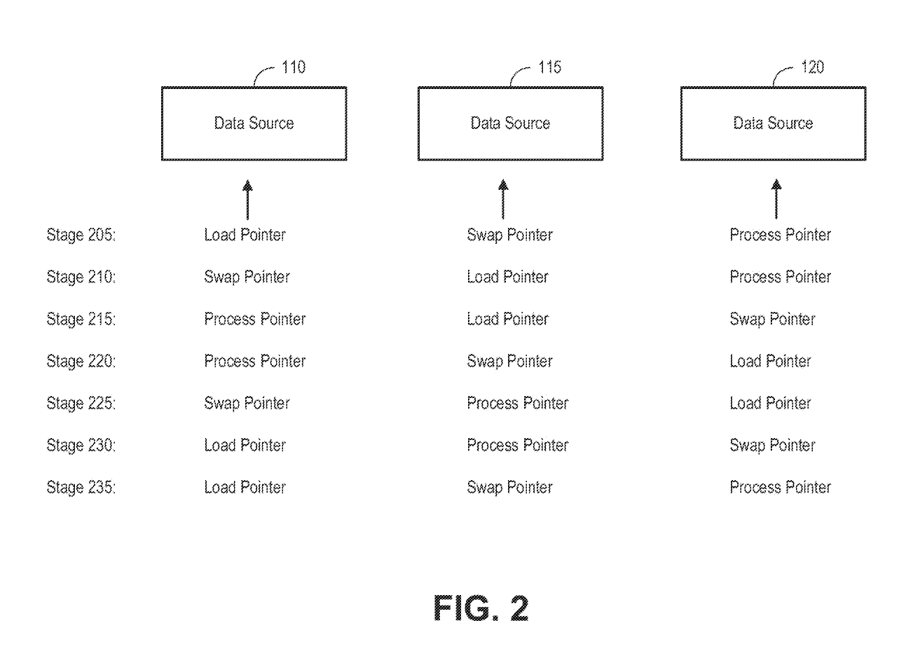

FIG. 1 illustrates an example system 100 for storing and processing data from a data source without copying the data to separate memory. The system 100 may include a data source 105, a first buffer 110, a second buffer 115, a third buffer 120, and a data requester 125. The illustrated data source 105 loads data into the buffer pointed to by a load pointer, wherein the data requester 125 may process data in the buffer pointed to by a process pointer. As will be illustrated below with reference to FIG. 2, by swapping pointers, the data requester 125 may process data loaded into buffers by data source 105 without copying the data to separate memory for processing.

As shown in FIG. 2, at stage 205, a load pointer points to the first buffer 110, a swap pointer points to the second buffer 115, and a process pointer points to the third buffer. At stage 205, since the load pointer points to the first buffer 110, the data source 105 may load data into the first buffer 110. Also, when the data source 105 fills up the first buffer 110, for example, the data source 105 then may acquire a semaphore lock to control access to swap pointer at stage 205 to store data into another buffer.

At stage 210, the load pointer may be swapped with the swap pointer so that the load pointer points to the second buffer 115 and the swap pointer points to the first buffer 110. Also at stage 210, a data ready signal may be provided (e.g., by data source 105) to the data requester 125, and the data source 105 also may release the semaphore lock acquired at stage 205.

At stage 215, the data requester 125 may acquire a semaphore lock to control access to the swap pointer. The process pointer then may be swapped with the swap pointer so that the process pointer points to the first buffer 110 and the swap pointer points to the third buffer 120. Since the process pointer now points to the first buffer 110, the data requester 125 may process the data stored in the first buffer 110 without copying the data to separate memory. Also, since the load pointer points to the second buffer 115, the data source 105 may load data into the second buffer 115. Also, when the data source 105 fills up the second buffer 115, for example, the data source 105 then may acquire a semaphore lock to control access to swap pointer to store data into another buffer.

At stage 220, the load pointer may be swapped with the swap pointer so that the load pointer points to the third buffer 120 and the swap pointer points to the second buffer 115. The data source 105 may then release the semaphore lock. Also at stage 220, a data ready signal may be provided (e.g., by data source 105) to the data requester 125.

At stage 225, for example when the data requester 125 completes processing the data stored in the first buffer 110, the data requester 125 may acquire a semaphore lock to control access to the swap pointer to process the next data. The process pointer then may be swapped with the swap pointer so that the process pointer points to the second buffer 115 and the swap pointer points to the first buffer 110. Since the process pointer now points to the second buffer 115, the data requester 125 may process the data stored in the second buffer 115 without copying the data to separate memory. Also, since the load pointer points to the third buffer 120, the data source 105 may load data into the third buffer 120. When the data source 105 fills up the third buffer 120, for example, the data source 105 then may acquire a semaphore lock to control access to swap pointer to store data into another buffer.

At stage 230, the load pointer may be swapped with the swap pointer so that the load pointer points to the first buffer 110 and the swap pointer points to the third buffer 120. The data source 105 may then release the semaphore lock. Also at stage 230, a data ready signal may be provided (e.g., by data source 105) to the data requester 125.

At stage 235, for example when the data requester 125 completes processing the data stored in the second buffer 115, the data requester 125 may acquire a semaphore lock to control access to the swap pointer. The process pointer then may be swapped with the swap pointer so that the process pointer points to the third buffer 120 and the swap pointer points to the second buffer 115. Since the process pointer now points to the third buffer 120, the data requester 125 may process the data stored in the third buffer 120 without copying the data to separate memory. Also, since the load pointer points to the first buffer 110, the data source 105 may load data into the first buffer 110. The data source 105 then may acquire a semaphore lock to control access to swap pointer.

The stages 210 through 235 may be repeated until all the data from the data source 105 is supplied to the buffers.

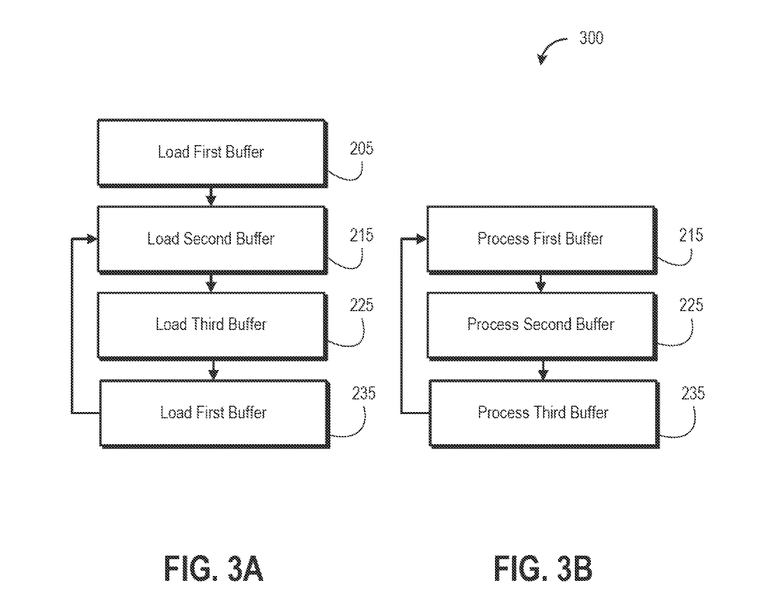

FIGS. 3A and 3B illustrate the load activity of the data source 105 and the process activity of data requester 125, respectively, based on the process described with reference to FIG. 2. At stage 205, the data source 105 loads data into the first buffer 110. At stage 215 the data source 105 loads data into the second buffer 115, and the data requester 125 processes the data stored in the first buffer 110. At stage 225, the data source 105 loads data into the third buffer 120, and the data requester 125 processes the data stored in the second buffer 115. At stage 235, the data source 105 loads data into the first buffer 110, and the data requester 125 processes the data stored in the third buffer 120. The stages 215 through 235 may be repeated until all the data from the data source 105 is supplied to the buffers.

As shown in FIGS. 2, SA and 3B, by swapping pointers, the data requester 125 may process data loaded into buffers by data source 105 without copying the data to separate memory for processing.

In some implementations, the system 100 may include additional buffers for the data source 105 to load data. In some implementations, the system 100 may include a plurality of data requesters processing the data in the buffers in parallel. In this case, each of the additional data requesters allocate its own data buffer and swap the corresponding pointer as taught with reference to FIG. 2.

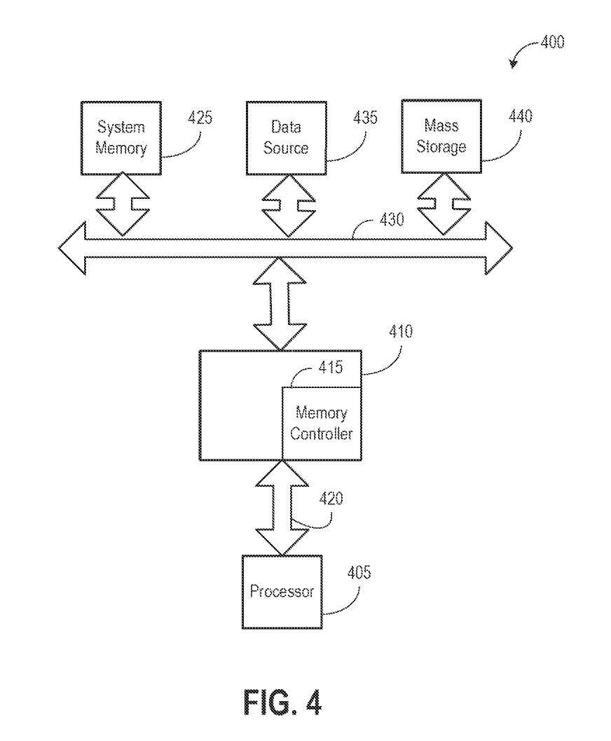

FIG. 4 illustrates an example computer system 400 that stores and processes data from a data source 435 without copying the data to separate memory.

The system 400 may include a processor 405 coupled to a bus controller 410 via a CPU bus 420. In some implementations, the system 400 may include multiple processors. The bus controller 410 may include a memory controller 415. In some implementations, the memory controller 415 may be external to the bus controller 410. The memory controller 415 may interface the processor 405 to a system memory 425 via a memory bus 430. In some implementations the system memory 425 may be described as a “main memory” of the system 400.

In some implementations, the system memory 425 may store information and instructions to be executed by processor 405. In some implementations, the system memory 425 may store instructions that when executed by a processor 405 causes the system 400 to execute the process or parts thereof of described with reference to FIG. 2. The system memory 425 may store data that is to be accessed by the processor to implement, for example, code to execute graphic operations. The system memory 425 may include dynamic random access memory (DRAM) modules that are accessed by the memory controller 415. In some implementations, the system memory 425 also may be used to store pixels that are part of one or more image frames received from the data source 435 to be processed by processor 405. For example, in some implementation, the system memory 425 may include the first buffer 110, the second buffer 115, and the third buffer 120 of FIG. 1. The data source 435 may include a processor and storage to store instructions that when executed by the processor causes the data source to execute parts of the process of FIG. 2.

The computer system 400 also may include a mass storage device 440 coupled to the memory bus 430. The mass storage device 440 may include, for example, a hard disk, floppy disk, compact disk read only memory (CD-ROM), digital video disk read only memory (DVD-ROM), tape, high density floppy, high capacity removable media, low capacity removable media, solid state memory device, and combinations thereof.

In some implementations, a graphics processor may process the frame data stored in buffers 110, 115, and 120. Computing devices contemplated to be within the scope of this disclosure include personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

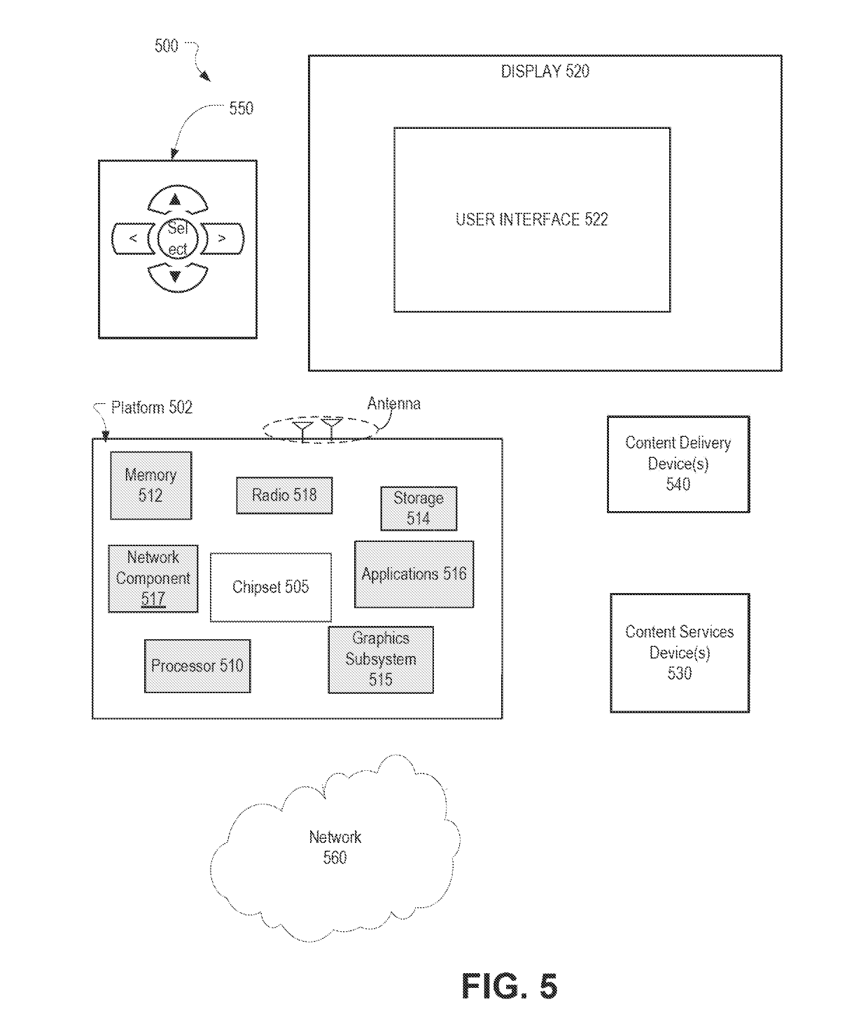

FIG. 5 illustrates an example embodiment of a system 500 of this disclosure comprising a platform 502, a display 520, content services device(s) 530, content delivery device(s) 540, and navigation controller 550. In embodiments, system 500 may be a media system although system 500 is not limited to this context. For example, components of system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/FDA, television, smart device (e.g., smart phone, smart tablet or smart television), mobile internet device (MID), messaging device, data communication device, and so forth.

In embodiments, system 500 comprises a platform 502 coupled to a display 520. Platform 502 may receive content from a content device such as content services device(s) 530 or content delivery device(s) 540 or other similar content sources. A navigation controller 550 comprising one or more navigation features may be used to interact with, for example, platform 502 and/or display 520. Each of these components is described in more detail below.

In embodiments, platform 502 may comprise any combination of a chipset 505, processor 510, memory 512, storage 514, graphics subsystem 515, applications 516, network component 517 (e.g., wired or wireless), and/or radio 518. Chipset 505 may provide intercommunication among processor 510, memory 512, storage 514, graphics subsystem 515, applications 516 and/or radio 518. For example, chipset 505 may include a storage adapter (not depicted) capable of providing intercommunication with storage 514.

Processor 510 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 510 may comprise single-core or multi-core processor(s), single-core or multi-core mobile processor(s), and so forth.

Memory 512 may be implemented as a volatile memory device such as, but not limited to, a Random Access Memory (RAM), Dynamic Random Access Memory (DRAM), or Static RAM (SRAM). In some embodiments, memory 512 may be implemented as a non-volatile memory such as a flash memory device. Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 514 may comprise technology to increase the storage performance enhanced protection for valuable digital media when multiple hard drives are included, for example.

Graphics subsystem 515 may perform processing of images such as still images or video for display. Graphics subsystem 515 may be a graphics processing unit (GPU) or a visual processing unit (VPU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. In embodiments, graphics subsystem 515 could be integrated into processor 510 or chipset 505. In embodiments, graphics subsystem 515 could be a stand-alone card communicatively coupled to chipset 505. The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 518 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks and satellite networks. In communicating across such networks, radio 518 may operate in accordance with one or more applicable standards in any version.

The network component 517 may include one or more network components capable of transmitting and receiving signals using various suitable wired and/or wireless communications techniques. Such techniques may involve communications across one or more wired and/or wireless networks. In communicating across such networks, network component 517 may operate in accordance with one or more applicable standards in any version. In embodiments, display 520 may comprise any television type monitor or display. Display 520 may comprise, for example, a computer display screen, touch screen display, video monitor, television-like device, and/or a television. Display 520 may be digital and/or analog. In embodiments, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In embodiments, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In embodiments, content services device(s) 530 may comprise a cable television box, personal computer, network, telephone, camera. Internet enabled devices or appliance capable of delivering digital information and/or content, and any other similar device capable of unidirectionally or bidirectionally communicating content between content providers and platform 502 and/display 520 directly or via network 560. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 receives content such as cable television programming including media information, digital information, and/or other content. Examples of content providers may include any cable or satellite television or radio or Internet content providers. The provided examples are not meant to limit embodiments of the invention.

In embodiments, platform 502 may receive control signals from navigation controller 550 having one or more navigation features. The navigation features of controller 550 may be used to interact with user interface 522, for example. In embodiments, navigation controller 550 may be a pointing device, a control pad, a keyboard, or a touch screen device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be echoed on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In embodiments, controller 550 may not be a separate component but integrated into platform 502 and/or display 520. Embodiments, however, are not limited to the elements or in the context shown or described herein.

In embodiments, drivers (not shown) may comprise technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 when the platform is turned “off” In addition, chipset 505 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the invention.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth, When implemented as a wired system, system 500 may include components and interfaces suitable for communicating over wired communications media, such as input/output (I/O) adapters, physical connectors to connect the I/O adapter with a corresponding wired communications medium, a network interface card (NIC), network controller (e.g. an Ethernet controller and ports—integrated or external), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

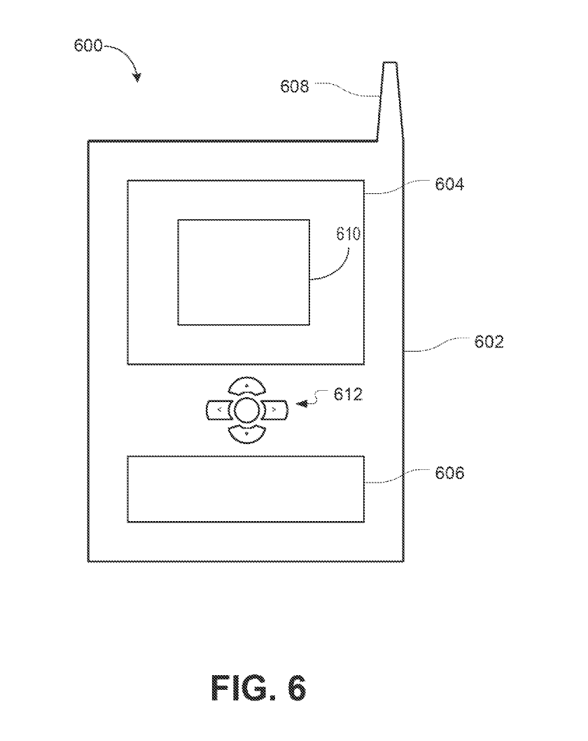

As described above, system 500 may be embodied in varying physical styles or form factors. FIG. 6 illustrates embodiments of a small form factor device 600 in which components of system 500 may be embodied. In embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications.

Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may comprise a housing 602, a display 604, an input/output (I/O) device 606, and an antenna 608. Device 600 also may comprise navigation features 612. Display 604 may comprise any suitable display unit such as a user interface 610 for displaying information appropriate for a mobile computing device.

I/O device 606 may comprise any suitable I/O device for entering information into a mobile computing device. Examples for device 606 may include an alphanumeric keyboard, a numeric keypad, a touch pad, input keys, buttons, switches, rocker switches, microphones, speakers, voice recognition device and software, and so forth. Information also may be entered into device 600 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, drivers, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments may therefore include a method including consecutively loading data into a plurality of buffers pointed to by a first pointer by consecutively swapping the first pointer to point to the plurality of buffers and consecutively processing the data loaded in the plurality of buffers by consecutively pointing a second pointer to the plurality of buffers by consecutively swapping the second pointer to point to the plurality of buffer.

Embodiments also may include a system including a plurality of buffers, a data source to load data into each buffer pointed to by a load pointer, a processor to process data in each buffer pointed to by a process pointer; and a computer readable medium including a set of instructions which, if executed by a processor, cause a computer to swap the load pointer to point to the plurality of buffers to load data, and swap the process pointer to point to the plurality of buffers to process the data.

Embodiments also may include a computer readable medium comprising a set of instructions which, if executed by a processor, cause a computer to consecutively load data into a plurality of buffers pointed to by a first pointer by consecutively swapping the first pointer to point to the plurality of buffers and consecutively process the data loaded in the plurality of buffers by consecutively pointing a second pointer to the plurality of buffers by consecutively swapping the second pointer to point to the plurality of buffer.

Embodiments may therefore include a method including initially pointing a load pointer to a first buffer, initially pointing a swap pointer to a second buffer, initially pointing a process pointer to a third buffer, loading data in the buffer pointed to by the load pointer, swapping the load pointer with the swap pointer and afterwards swapping the process pointer with the swap pointer, and loading the data in the buffer pointed to by the load pointer and processing the data in the buffer pointed to by the process pointer.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground. connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention may be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system comprising:
a plurality of buffers;
a data source to load data into each buffer pointed to by a load pointer;
a processor to process data in each buffer pointed to by a process pointer; and
a computer readable medium including a set of instructions which, if executed by a processor, cause a computer to:
swap the load pointer to point to the plurality of buffers to load data, and
swap the process pointer to point to the plurality of buffers to process the data.

2. The system of claim 1, wherein the data source is a camera

3. The system of claim 1, wherein the data source is a streaming video source.

4. The system of claim 1, wherein the data source is an output of a video processing thread.

5. The system of claim 1, wherein the processor is a graphic processor.

6. The system of claim 1, a processor to process data in each buffer pointed to by a plurality of pointers corresponding to the plurality of processing threads.

7. A method comprising:
consecutively loading data into a plurality of buffers pointed to by a first pointer by consecutively swapping the first pointer to point to the plurality of buffers; and
consecutively processing the data loaded in the plurality of buffers by
consecutively pointing a second pointer to the plurality of buffers by consecutively swapping the second pointer to point to the plurality of buffer.

8. The method of claim 7, further comprising acquiring a semaphore lock to control access to a swap pointer when swapping the first pointer and second pointer.

9. The method of claim 7, further comprising providing a data ready signal to indicate that one of the plurality of buffers has been loaded.

10. The method of claim 7, wherein the data consecutively loaded into the plurality of buffers is frame data.

11. The method of claim 7, wherein the data consecutively loaded into the plurality of buffers is image data.

12. The method of claim 7, wherein consecutively processing the data loaded in the plurality of buffers comprises performing a video processing algorithm of the data loaded in the plurality of buffers.

13. The method of claim 7, wherein a plurality of processing threads consecutively process the data loaded in the plurality of buffers by consecutively pointing a plurality of pointers corresponding to the plurality of processing threads respectively to the plurality of buffers by consecutively swapping the plurality of pointers to point to the plurality of buffer.

14. A computer readable medium comprising a set of instructions which, if executed by a processor, cause a computer to:
consecutively load data into a plurality of buffers pointed to by a first pointer by consecutively swapping the first pointer to point to the plurality of buffers; and
consecutively process the data loaded in the plurality of buffers by consecutively pointing a second pointer to the plurality of buffers by consecutively swapping the second pointer to point to the plurality of buffer.

15. The computer readable medium of claim 14, further comprising a set of instructions which, if executed by a processor, cause a computer to acquire a semaphore lock to control access to a swap pointer when swapping the first pointer and second pointer.

16. The computer readable medium of claim 14, further comprising a set of instructions which, if executed by a processor, cause a computer to provide a data ready signal to indicate that one of the plurality of buffers has been loaded.

17. The computer readable medium of claim 14, wherein the data consecutively loaded into the plurality of buffers is frame data.

18. The computer readable medium of claim 14, wherein the data consecutively loaded into the plurality of buffers is image data.

19. The computer readable medium of claim 14, wherein to consecutively process the data loaded in the plurality of buffers include to perform a video processing algorithm of the data loaded in the plurality of buffers.

20. The computer readable medium of claim 14, wherein a plurality of processing threads consecutively process the data loaded in the plurality of buffers by consecutively pointing a plurality of pointers corresponding to the plurality of processing threads respectively to the plurality of buffers by consecutively swapping the plurality of pointers to point to the plurality of buffer.

21. A method comprising:
initially pointing a load pointer to a first buffer;
initially pointing a swap pointer to a second buffer;
initially pointing a process pointer to a third buffer;
loading data in the buffer pointed to by the load pointer;
swapping the load pointer with the swap pointer and afterwards swapping the process pointer with the swap pointer; and
loading the data in the buffer pointed to by the load pointer and processing the data in the buffer pointed to by the process pointer.

22. The method of claim 21, further comprising acquiring a semaphore lock to control access to a swap pointer when swapping the load pointer and process pointer.

23. The method of claim 21, further comprising providing a data ready signal to indicate that a buffer has been loaded.

24. The method of claim 21, wherein the data loaded into the buffer is frame data.

25. The method of claim 21, wherein the data loaded into the buffer is image data.

26. The method of claim 21, wherein processing the data loaded in the buffer comprises performing a video processing algorithm of the data loaded in the buffer.
